(19) United States
(12) Patent Application Publication
(10) Pub. No.: US 2008/0178857 A1
(43) Pub. Date: Jul. 31, 2008

(54) DRIVE DEVICE MOUNTED IN VEHICLE BODY WHICH INCLUDES VARIABLE COMPRESSION RATIO INTERNAL COMBUSTION ENGINE

(75) Inventor: Eiichi KAMIYAMA, Mishima-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 11/860,129

(22) Filed: Sep. 24, 2007

(30) Foreign Application Priority Data
Sep. 26, 2006 (JP) 2006-260792

(51) Int. Cl. F02B 75/04; F02F 7/00

(52) U.S. Cl. 123/78 C; 123/195 R

(57) ABSTRACT

A drive device includes a variable compression ratio internal combustion engine that moves a cylinder block relative to crankcase in a cylinder axis direction, and a transmission device. A chain case is made up of a crankcase-side chain case fixed to the crankcase, and a cylinder block-side chain case fixed to the cylinder block. An upper portion of the crankcase-side chain case is supported on a vehicle body via a support member. The transmission device is supported on a vehicle body via a support member. A support member coupling portion that fixes the support member of the crankcase-side chain case includes a rib that improves the rigidity of a front wall portion of the crankcase-side chain case.

### INCORPORATION BY REFERENCE

The disclosure of Japanese Patent Application No. JP-2006-260792 filed on Sep. 26, 2006 including the specification, drawings and abstract is incorporated herein by reference in its entirety.

### BACKGROUND OF THE INVENTION

1. Field of the Invention

The invention relates to a drive device mounted in a vehicle body which includes a variable compression ratio internal combustion engine capable of changing the compression ratio.

2. Description of the Related Art

In the related art, there has been proposed a piston reciprocating type variable compression ratio internal combustion engine that changes the compression ratio by moving a cylinder block relative to a crankcase in the direction of an axis of a cylinder (hereinafter, referred to simply as “the up-down direction”) (see, e.g., Japanese Patent Application Publication No. 2003-206771 (JP-A-2003-206771)).

Incidentally, a piston reciprocating type internal combustion engine has a chain mechanism for rotating a crankshaft and camshafts in a coordinated manner, and a chain case that covers the chain mechanism. The chain mechanism is provided on a front surface of an engine body (including the crankcase and the cylinder block) (i.e., a surface of the engine body opposite from a surface thereof to which a transmission device is coupled). The chain case is fixed to the engine body by bolts.

On the other hand, a drive device of a vehicle which includes an internal combustion engine and a transmission device is supported on a vehicle body at least two sites. For example, one of the two sites is the chain case that constitutes a front surface of the engine body, and the other site is the transmission device.

The chain case of the aforementioned variable compression ratio internal combustion engine is divided into a cylinder block-side chain case fixed to the cylinder block and a crankcase-side chain case fixed to the crankcase since the cylinder block and the crankcase are moved relative to each other. However, it has not been thoroughly considered how a drive device that includes a variable compression ratio internal combustion engine provided with divided chain cases and a transmission device is to be supported on a vehicle body.

### SUMMARY OF THE INVENTION

A drive device mounted in a vehicle body in accordance with a first aspect of the invention includes a transmission device, and a variable compression ratio internal combustion engine that includes a crankcase that rotatably supports a crankshaft coupled to the transmission device, and a cylinder block disposed above the crankcase, and that is capable of changing a compression ratio by moving the cylinder block relative to the crankcase in a cylinder axis direction.

This drive device includes a support member whose portion is supported on the vehicle body in order to support the drive device on the vehicle body, a cylinder block-side chain case fixed to the cylinder block so as to cover a front surface of the cylinder block that is a surface opposite from a side of the cylinder block where the transmission device is disposed, and a crankcase-side chain case which is fixed to the crankcase so as to cover a front surface of the crankcase that is a surface opposite from a side of the crankcase where the transmission device disposed, and which has a support member coupling portion that couples to another portion of the support member.

In the drive device of this aspect, the chain case is made up of the cylinder block-side chain case and the crankcase-side chain case. Furthermore, a portion of the support member (e.g., an engine mount bracket) is supported on the vehicle body, and another portion of the support member is coupled to the crankcase-side chain case by the support member coupling portion. Therefore, when the compression ratio of the internal combustion engine is changed, the cylinder block, which is relatively light in weight, is moved in the up-down direction relative to the crankcase and a structure body coupled to the crankcase, which are heavy in weight and are supported on or fixed to the vehicle body. As a result, the energy needed in order to change the compression ratio can be reduced.

If a construction in which the cylinder block is supported on the vehicle body and the crankcase is suspended from the cylinder block is adopted, it becomes necessary to lift the crankcase and the structure bodies coupled to the crankcase which are heavy in weight, when the compression ratio is to be raised; therefore, there arises possibility of the compression ratio-changing mechanism being increased in size. In contrast, according to the foregoing construction, since the whole internal combustion engine (i.e., the cylinder block and the crankcase) is supported on the vehicle body by supporting the crankcase located below the cylinder block on the vehicle body via the support member, size increase of the compression ratio-changing mechanism can be avoided.

In the drive device, the crankcase-side chain case may have a side wall portion that contacts a vicinity of a left-side end portion of the front surface of the crankcase and a vicinity of a right-side end portion of the front surface of the crankcase and that extends in a direction orthogonal to the front surface of the crankcase, and a front wall portion that is contiguous to the side wall portion and that faces the front surface of the crankcase, and the support member coupling portion may include a support member fixture portion which another portion of the support member is in contact with and is fixed to, and a rib that extends from the support member fixture portion and that is contiguous to the front wall portion so as to improve a rigidity of the front wall portion.

In the instance where a support member coupling portion is provided on the crankcase-side chain case as in the drive device of the foregoing aspect, it sometimes happens that a great force from the vehicle body through the support member (in particular, a component force along the direction orthogonal to the front surface of the crankcase) is exerted on the crankcase-side chain case. Therefore, there is possibility of deformation of the front wall portion that constitutes the front surface portion of the crankcase-side chain case. However, in the foregoing construction, the front wall portion is reinforced by the rib of the support member coupling portion, so that deformation of the front wall portion can be prevented. As a result, for example, it becomes possible to avoid a problem of lubricating oil leaking from the chain case.

In this instance, the rib may be formed so as to extend from the support member fixture portion to a portion of the side wall portion. The portion of the side wall portion that the rib extends to (the rib reaches) is, for example, a portion of an end portion of the side wall portion that is opposite from a portion of the side wall portion that is in contact with the crankcase.

According to this construction, the great force exerted on the support member fixture portion in the direction orthogonal to the front surface of the crankcase is transmitted to the portion of the side wall portion through the rib. On the other hand, the side wall portion is in contact with the front surface of the crankcase, and extends in the direction orthogonal to the front surface of the crankcase. Therefore, the side wall portion does not deform under the great force in the direction orthogonal to the front surface of the crankcase, but transmits the force to the front surface of the crankcase. As a result, it becomes possible to prevent deformation of the crankcase-side chain case (in particular, the front wall portion), and it becomes possible to avoid occurrence of a problem of, for example, lubricating oil leaking from the chain case.

In the foregoing aspect, a first bolt-purpose seat surface for fixing the crankcase-side chain case and the crankcase to each other may be formed in a portion of the side wall portion that extends from a rib-reach region that is a region in the side wall portion in which the rib reaches the side wall portion, in the direction orthogonal to the front surface of the crankcase, and that contacts the front surface of the crankcase.

According to this construction, the great force exerted on the support member fixture portion in the direction orthogonal to the front surface of the crankcase is more reliably transmitted to the front surface of the crankcase by the rib, the side wall portion and the first bolt. As a result, deformation of the front wall portion of the crankcase-side chain case can be more reliably prevented. In this instance, if the support member fixture portion is disposed above an upper end of the side wall portion, a more remarkable effect of preventing deformation of the front wall surface can be achieved. This can be explained as follows. That is, in a vicinity of the upper end of the side wall portion and the front wall portion contiguous to the vicinity of the upper end of the side wall portion (hereinafter, referred to as “the side wall upper end-adjacent portion” for the sake of convenience), the rigidity is relatively small. Besides, provided that a fixed moment load M is input, the force F (load) exerted on the side wall upper end-adjacent portion becomes smaller (follows M=F•x) the longer the distance x to the side wall upper end-adjacent portion from a point at which the crankcase-side chain case is supported on the vehicle body via the support member.

In this instance, a second bolt-purpose seat surface for fixing the crankcase-side chain case and the crankcase to each other may be formed in another portion of the side wall portion that extends from a rib non-reach region that is another region in the side wall portion in which the rib does not reach the side wall portion, in the direction orthogonal to the front surface of the crankcase, and a diameter of a second bolt that uses the second bolt-purpose seat surface may be smaller than a diameter of a first bolt that uses the first bolt-purpose seat surface.

According to this construction, the crankcase-side chain case and the crankcase are fastened to each other with the large-diameter bolt being used for the portion to which the great force input to the crankcase-side chain case via the support member is transmitted, and with the small-diameter second bolt being used for a portion to which the great force is not transmitted. As a result, it becomes possible to set the rigidity, the fastening force, etc., in the fastening sites between the crankcase-side chain case and the crankcase at necessary values while reducing the number of the large-diameter bolts (heavy in weight). Therefore, the weight of the internal combustion engine can be reduced.

Furthermore, in the instance where the crankcase-side chain case includes the rib, at least a portion of the rib may include an extended-out portion that is extended out so as to contact the front surface of the crankcase, and a third bolt-purpose seat surface for fixing the crankcase-side chain case and the crankcase to each other may be formed in the extended-out portion.

According to this construction, the great force exerted on the crankcase-side chain case through the support member in the direction orthogonal to the front surface of the crankcase can be transmitted to the front surface of the crankcase through the rib, the extended-out portion extending out from the rib, and the third bolt. As a result, deformation of the crankcase-side chain case (in particular, of the front wall portion) can be more reliably prevented.

In this instance, it is desirable that a diameter of a third bolt that uses the third bolt-purpose seat surface be larger than a diameter of the second bolt that uses the second bolt-purpose seat surface. As a result, large-diameter bolts are used only at the sites where great force is exerted, so that the rigidity, the fastening force, etc., at the fastening sites between the crankcase-side chain case and the crankcase can be set at necessary values, and increase of the weight of the internal combustion engine can be restrained.

In addition, in any of the foregoing constructions of the drive device, the portion of the support member that is supported on the vehicle body may be supported on the vehicle body at a first position that is above an upper end of the crankcase, and the transmission device may be supported on the vehicle body at a second position, and the first position may be set at such a position that a center of gravity of a structure body of the drive device that excludes a structure body that moves together with the cylinder block when the compression ratio is changed may be below a straight line that connects the first position and the second position.

According to this construction, the center of gravity of the structure body (that includes mainly the crankcase and the transmission device, and that will be referred to as “non-mobile portion) of the drive device that excludes the structure body that moves together with the cylinder block when the compression ratio is changed is located below the straight line that connects the first position and the second position (i.e., the mount axis). Therefore, the non-mobile portion can be more stably supported than in the instance where the center of gravity of the non-mobile portion, which is heavy in weight, is above the mount axis, so that the whole drive device that includes the cylinder block, which is a movable portion for changing the compression ratio, can be more stably supported. As a result, since the force exerted on the crankcase-side chain case from the vehicle body can be reduced, deformation of the crankcase-side chain case can be restrained. Besides, since the first position is determined in this manner, it becomes possible to cause the mount axis to coincide with the principal axis of inertia. As a result, it becomes possible to support the drive device while maintaining the effect of reducing the vibration transmitted from the drive device to the vehicle body.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a schematic side view of a drive device in accordance with an embodiment of the invention;

FIG. 2 is a sectional view of the internal combustion engine shown in FIG. 1 which is taken on a plane that is orthogonal to a plane containing a cylinder arrangement direction and that passes through a center axis of one of the cylinders;

FIG. 3 is an exploded partial perspective view of the internal combustion engine shown in FIG. 1;

FIG. 4 is a perspective view of a cylinder block shown in FIG. 1;

FIGS. 5A, 5B and 5C are diagrams for describing an operation of a compression ratio-changing mechanism provided for the internal combustion engine shown in FIG. 1;

FIG. 6 is a perspective view of a chain case when the compression ratio of the internal combustion engine shown in FIG. 1 is the highest compression ratio;

FIG. 7 is a perspective view of the chain case when the compression ratio of the internal combustion engine shown in FIG. 1 is the lowest compression ratio;

FIG. 8 is a side view of a crankcase-side chain case, a cylinder block-side chain case, and portions near the chain cases which are shown in FIG. 1;

FIGS. 9A, 9B are conceptual diagrams for describing forces that act on the crankcase shown in FIG. 1;

FIG. 10 is a perspective view of a crankcase-side chain case in accordance with a first modification in the invention;

FIG. 11 is a perspective view of a portion of the crankcase-side chain case shown in FIG. 10 which is viewed from a reverse side thereof; and

FIG. 12 is a perspective view of a crankcase-side chain case in accordance with a second modification in the invention.

### DETAILED DESCRIPTION OF THE EMBODIMENTS

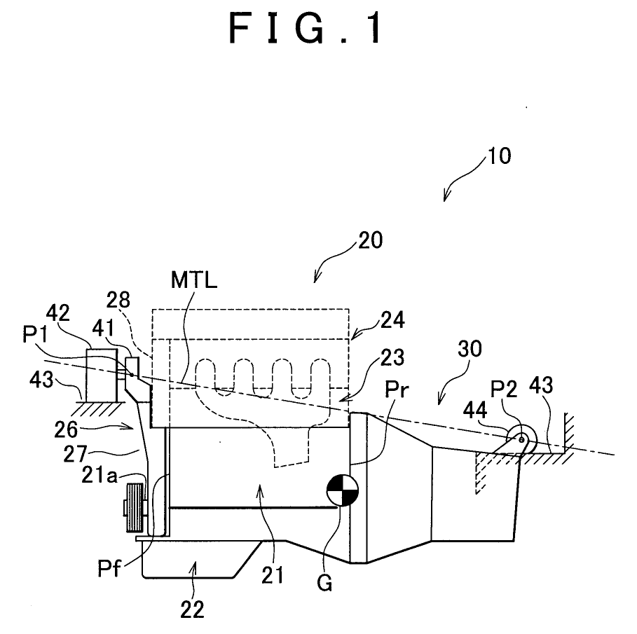

Hereinafter, embodiments of a drive device (a support structure of a drive device) that includes a variable compression ratio internal combustion engine and a transmission device in accordance with the invention will be described with reference to the drawings. A drive device 10 is mounted in a front engine front wheel drive type vehicle. The drive device 10, as shown in FIG. 1, includes a variable compression ratio internal combustion engine (hereinafter, sometimes referred to simply as internal combustion engine” of “engine”) 20, and a transmission device 30. In this specification, to simplify the description of the internal combustion engine 20 and the transmission device 30, the description and illustration of some of the component elements thereof is omitted.

The internal combustion engine 20 includes a crankcase 21, an oil pan 22, a cylinder block 23, and a cylinder head portion 24.

The crankcase 21 rotatably supports a crankshaft 21a. The crankshaft 21a is coupled to the transmission device 30 so as to be able to transmit power to the transmission device 30. Hereinafter, a surface Pr of the crankcase 21 that is on the side on which the transmission device 30 is disposed will be termed the rear surface Pr of the crankcase 21, and a surface Pf of the crankcase 21 opposite from the rear surface will be termed the front surface Pf of the crankcase 21. These terms apply to the cylinder block 23 in the same manner.

The oil pan 22 is fixed to the crankcase 21 at a location that is below or downward relative to the crankcase 21 (fixed to a lower portion of the crankcase 21). Herein, the term “downward” means a direction from a given point on the drive device 10 toward the ground surface when the drive device 10 is mounted in a vehicle body. Therefore, the term “upward” means a direction from a given point on the drive device 10 toward the sky. The oil pan 22, together with the crankcase 21, defines a space in which the crankshaft 21a, a lubricating oil, etc., are housed.

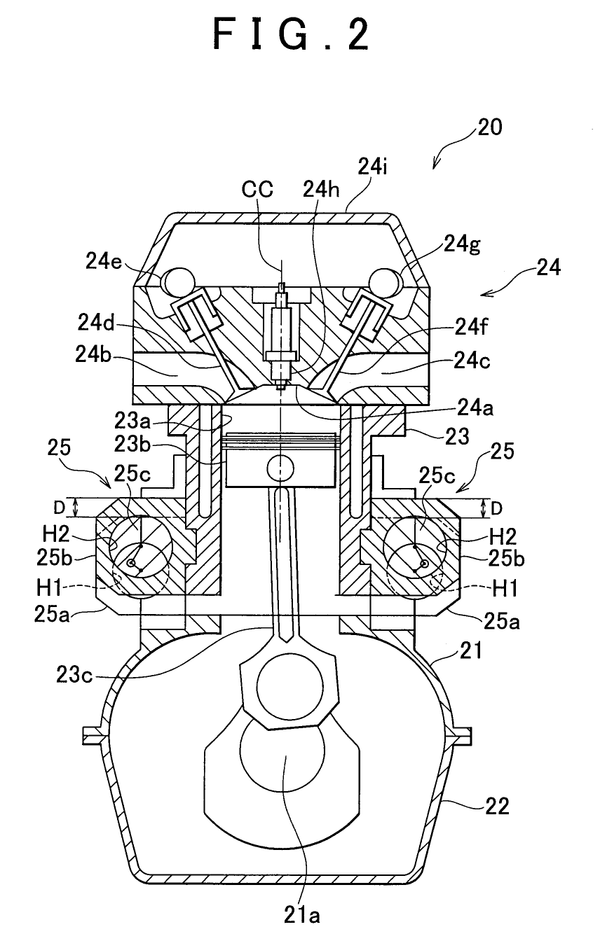

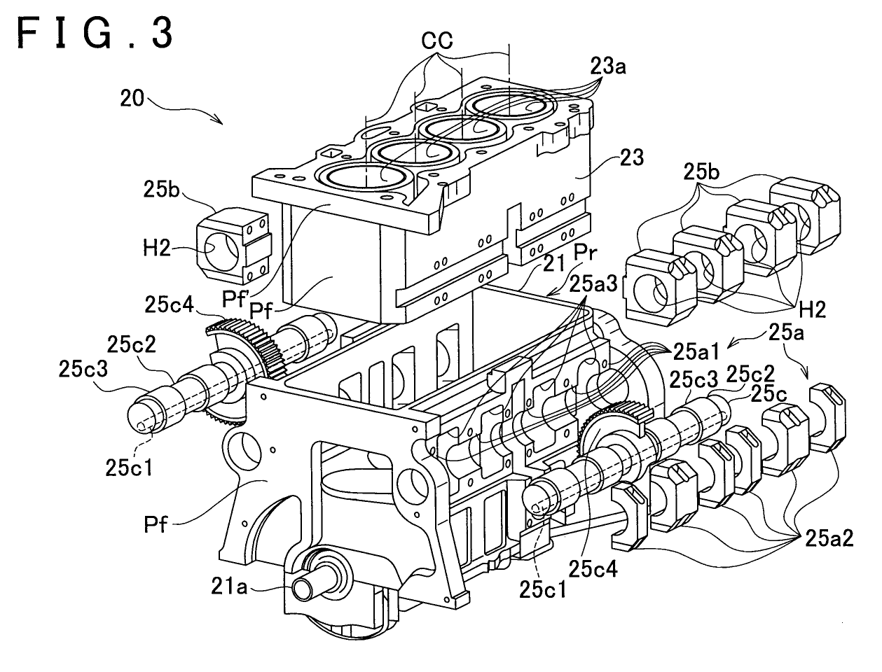

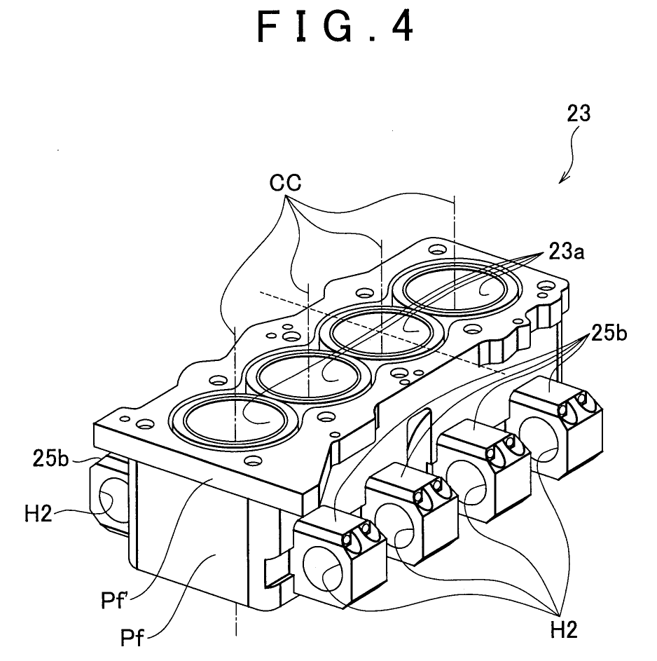

The cylinder block 23 is disposed at a location that is upward relative to the crankcase 21. The cylinder block 23 includes a plurality of hollow cylindrical cylinders (cylinder bores) 23a (e.g., four cylinders) that are arranged in line in a longitudinal direction of the cylinder block, as shown in FIG. 2, which is a sectional view of the internal combustion engine 20, and FIG. 3, which is an exploded partial perspective view of the internal combustion engine 20, and FIG. 4, which is a perspective view of the cylinder block 23. That is, the axes CC of the cylinders 23a are positioned so as to intersect with a straight line that extends in the longitudinal direction of the cylinder block 23 (a straight line orthogonal to the front surface Pf of the cylinder block 23). Each cylinder 23a houses a generally cylindrical piston 23b as shown in FIG. 2. The pistons 23b are coupled to the crankshaft 21a via connecting rods 23c. The cylinder block 23 is constructed so that the compression ratio can be changed by moving the cylinder block 23 relative to the crankcase 21 in the direction of the axes CC of the cylinders 23a, as described below.

The cylinder head portion 24, is disposed above the cylinder block 23, and is fixed to the cylinder block 23, as shown in FIGS. 1 and 2. The cylinder head portion 24, as shown in FIG. 2, has a cylinder head lower surface 24a that partially defines a combustion chamber, an intake port 24b that communicates with the combustion chamber, and an exhaust port 24c that communicates with the combustion chamber, for each cylinder. Furthermore, the cylinder head portion 24 houses intake valves 24d that open and close the intake ports 24b, an intake camshaft 24e that drives the intake valves 24d, exhaust valves 24f that open and close the exhaust ports 24c, an exhaust camshaft 24g that drives the exhaust valves 24f, and ignition plugs 24h, etc. A head cover 24i is fixed to an upper portion of the cylinder head portion 24.

As shown in FIG. 2, the internal combustion engine 20 has a compression ratio-changing mechanism 25 for changing the compression ratio. This compression ratio-changing mechanism 25 is substantially the same as the mechanism disclosed in Japanese Patent Application Publication No. 2003-206771 (JP-A-2003-206771), which is aforementioned related-art. Therefore, the compression ratio-changing mechanism 25 will be briefly described with reference to FIGS. 2 to 4.

The compression ratio-changing mechanism 25 includes a case-side bearing-forming portion 25a, a block-side bearing-forming portion 25b, and a shaft-shaped drive portion 25c.

The case-side bearing-forming portion 25a is constructed of a plurality of first bearing-forming portions 25a1 and a plurality of second bearing-forming portions 25a2.

The first bearing-forming portions 25a1 are formed in a vertical wall portion near an upper end portion of each of left and right side walls of the crankcase 21. Each first bearing-forming portion 25a1 has a semicircular recess portion. Each semicircular recess portion is formed at a position that corresponds to a position between adjacent cylinders 23a when the cylinder block 23 is disposed in an upper portion of the crankcase 21. Bolt holes are formed above and below each recess portion. Incidentally, in this specification, a bolt being formed and a bolt-purpose seat surface being formed mean substantially the same.

Vertically elongated holes 25a3 are formed between adjacent first bearing-forming portions 25a1 in each of the two vertical wall portions so that each vertically elongated hole 25a3 extends through the vertical wall portion. That is, the vertically elongated holes 25a3 are formed in regions in the left and right side walls of the crankcase 21 which include intersecting portions between the left and right side walls and straight lines that intersect with the axes CC of the cylinders 23a and that are orthogonal to the plane that passes through the axes CC of the cylinders 23a (cylinder axes-arrangement plane), in a state where the cylinder block 23 is disposed on the crankcase 21.

Each second bearing-forming portion 25a2 is a cap that is bolted to a corresponding one of the first bearing-forming portions 25a1. Each second bearing-forming portion 25a2 has a semicircular recess portion that is equal in diameter to the semicircular recess portions of the first bearing-forming portions 25a1.

Each second bearing-forming portion 25a2 is fixed to a corresponding one of the first bearing-forming portions 25a1 via bolts inserted into the aforementioned bolt holes so that the semicircular recess portion of the first bearing-forming portion 25a1 and the semicircular recess portion of the second bearing-forming portion 25a2 face each other. As a result, a plurality of cylindrical bearing holes (cam housing holes) H1 shown in FIG. 2 are formed. The center axes of the bearing holes H1 on each of the left and right sides are aligned on a single straight line. The axis of the bearing holes H1 on each side extends parallel to the arrangement direction of the cylinders 23a (a straight line that intersects orthogonally with the axes CC of the cylinders 23a), in a state in which the cylinder block 23 is disposed in an upper portion of the crankcase 21.

Each block-side bearing-forming portion 25b is a generally rectangular parallelepiped as shown in FIGS. 2 to 4, and has a cylindrical bearing hole H2. Each block-side bearing-forming portion 25b is housed in a corresponding one of the vertically elongated holes 25a3 formed in the vertical wall portions of the crankcase 21, and is bolted to a corresponding portion of the left or right side wall portion of the cylinder block 23 which is near a crankcase 21-side end portion of the cylinder block 23 (a lower end portion of the cylinder block 23), in a state where the cylinder block 23 is disposed in an upper portion of the crankcase 21. In this construction, the bearing holes H1 and the bearing holes H2 are alternately aligned along the arrangement direction of the cylinders 23a.

The length of the vertically elongated holes 25a3 in the direction of the cylinder axes CC is set longer than the length of the block-side bearing-forming portions 25b fixed to the cylinder block 23 which is measured in the direction of the cylinder axes CC. Thus, the block-side bearing-forming portions 25b are movable integrally with the cylinder block 23 in the direction of the cylinder axes CC relative to the crankcase 21.

When all the block-side bearing-forming portions 25b have been fixed to the cylinder block 23, the center axes of the bearing holes H2 of the block-side bearing-forming portions 25b on each of the left and right sides are aligned on a single straight line. The axis of the bearing holes H2 on each side extends parallel to the arrangement direction of the cylinders 23a. The distance between the axes of the bearing holes H2 formed at the left and right side wall portions of the cylinder block 23 is the same as the distance between the axes of the bearing holes H1 formed at the left and right sides of the crankcase 21.

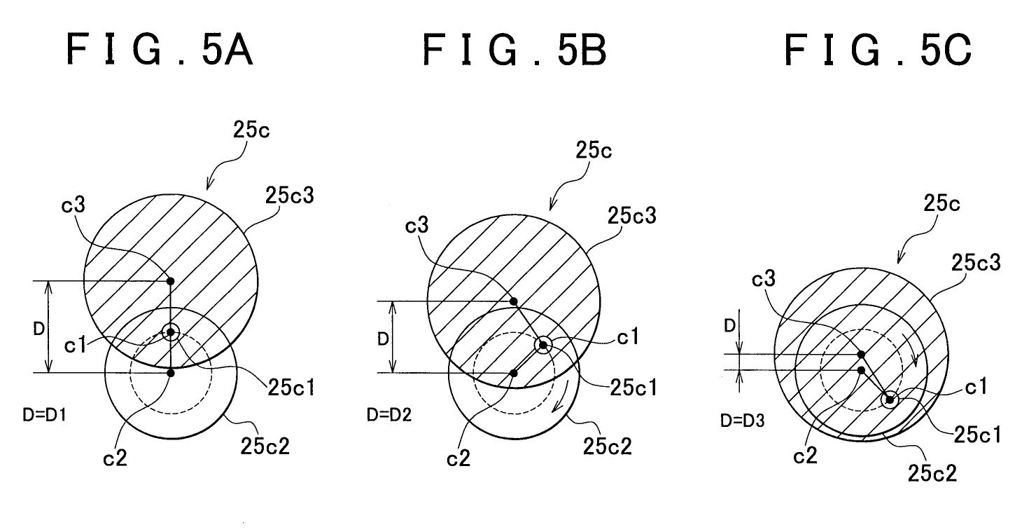

On the other hand, the shaft-shaped drive portion 25c is inserted through the bearing holes H1 and the bearing holes H2 on each side. As shown in FIG. 3 and FIGS. 5A to 5C, which are sectional views of one of the shaft-shaped drive portions 25c, each shaft-shaped drive portion 25c has a small-diameter shaft portions 25c1, fixed cylindrical portions 25c2 fixed to the shaft portions 25c1 while being eccentric to the center axis of the shaft portions 25c1, and rotary cylindrical portions 25c3 attached rotatably to the shaft portions 25c1 while being eccentric to the center axis of the shaft portions 25c1.

The fixed cylindrical portions 25c2 are cylindrical members that are larger in diameter than the shaft portions 25c1, and have the same perfect circular cam profile as the bearing holes H1. The fixed cylindrical portions 25c2 are housed in the bearing holes H1 that are formed in the case-side bearing-forming portions 25a of the crankcase 21. The fixed cylindrical portions 25c2 are constructed so as to rotate about the center axis thereof while being in contact with the wall surface of the bearing holes H1.

The rotary cylindrical portions 25c3 are cylindrical members that are larger in diameter than the shaft portions 25c1 and the fixed cylindrical portions 25c2, and have the same perfect circular cam profile as the bearing holes H2. The rotary cylindrical portions 25c3 are housed in the bearing holes H2 that are formed in the block-side bearing-forming portions 25b fixed to the cylinder block 23. Each of the rotary cylindrical portions 25c3 is constructed so as to rotate in contact with the wall surface of a corresponding one of the bearing holes H2. Incidentally, the left and right shaft-shaped drive portions 25c, the left and right bearing holes H1, and the left and right bearing holes H2 have a mirror image relationship with each other with respect to the plane that passes through the cylinder axes CC.

Furthermore, each of the shaft-shaped drive portions 25c has a gear 25c4 near a center position on the shaft-shaped drive portion 25c in the direction of the axis thereof. The gear 25c4 is fixed so as to be eccentric to the center axis of the shaft portion 25c1, and be coaxial with the fixed cylindrical portions 25c2 (therefore, coaxial with the bearing holes H1). That is, the center axis of rotation of the gear 25c4 coincides with the center axis of the fixed cylindrical portions 25c2. Each of the two gears 25c4 on both sides in mesh with a corresponding one of two worm gears (not shown). The worm gears are attached to an output shaft of a motor (not shown) that is fixed to the crankcase 21. The two worm gears have spiral grooves that are opposite in the rotation direction to each other. Therefore, when the motor is rotated, the two shaft-shaped drive portions 25c rotate about the center axes of the their fixed cylindrical portions 25c2 in directions opposite to each other.

FIGS. 5A, 5B and 5C are diagrams conceptually showing motion of the shaft-shaped drive portion 25c that is located on the right side of the crankcase 21 and the cylinder block 23 when viewed from the side of the front surfaces Pf thereof. For example, when, as shown in FIG. 5A, the center c2 of the fixed cylindrical portions 25c2, the center c1 of the shaft portions 25c1, and the center c3 of the rotary cylindrical portions 25c3 are positioned on a straight line in this order, the distance D between the crankcase 21 (the center of the bearing holes H1) and the cylinder block 23 (the center of the bearing holes H2) becomes equal to a distance D1, which is the maximum distance. Therefore, the volume of the combustion chamber occurring when the piston 23b is at the top dead center position is large. As a result, the compression ratio of the internal combustion engine 20 is low.

If from the state shown in FIG. 5A, the motor is driven to rotate the fixed cylindrical portions 25c2 about the center axis of the fixed cylindrical portions 25c2, a state shown in FIG. 5B is assumed. At this time, the distance D is equal to the distance D2. Furthermore, if from the state shown in FIG. 5B, the motor is driven in the same rotation direction as mentioned above, the fixed cylindrical portions 25c2 rotate further about the center axis of the fixed cylindrical portions 25c2. At this time, the distance D is equal to the distance D3. The distance D3 is less than the distance D2 and the distance D2 is less than the distance D1. Therefore, the compression ratio during the state shown in FIG. 5B is higher than the compression ratio during the state shown in FIG. 5A, and the compression ratio during the state shown in FIG. 5C is higher than the compression ratio during the state shown in FIG. 5B. In this manner, the compression ratio is changed in the internal combustion engine 20.

Referring back to FIG. 1, the internal combustion engine 20 has a chain case 26. The chain case 26 is provided on the side of the front surfaces Pf of the crankcase 21 and the cylinder block 23 (i.e., the side of the front surface of the internal combustion engine 20), and covers a chain mechanism provided for rotating the crankshaft and the camshaft in coordination. The chain mechanism is supplied with lubricating oil from the front surface Pf of the crankcase 21 by a well-known mechanism (not shown).

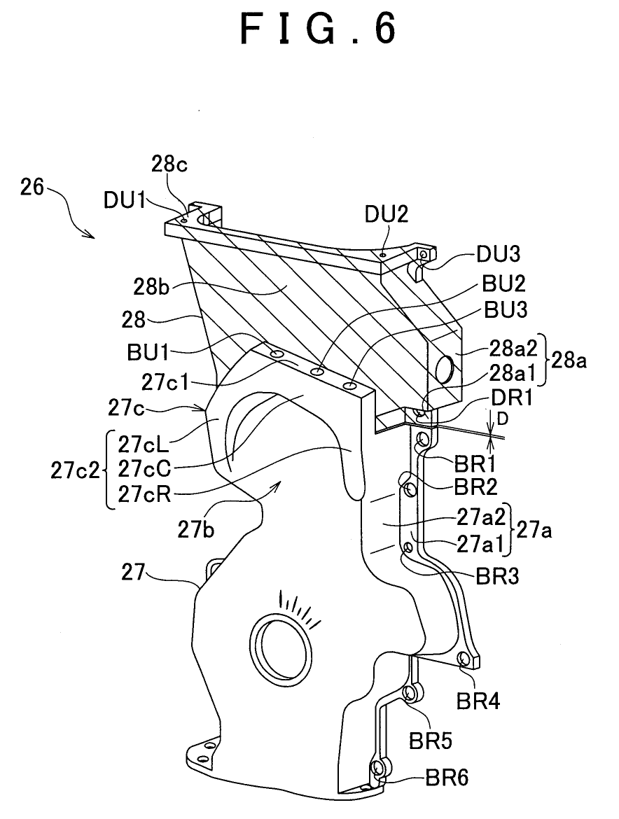

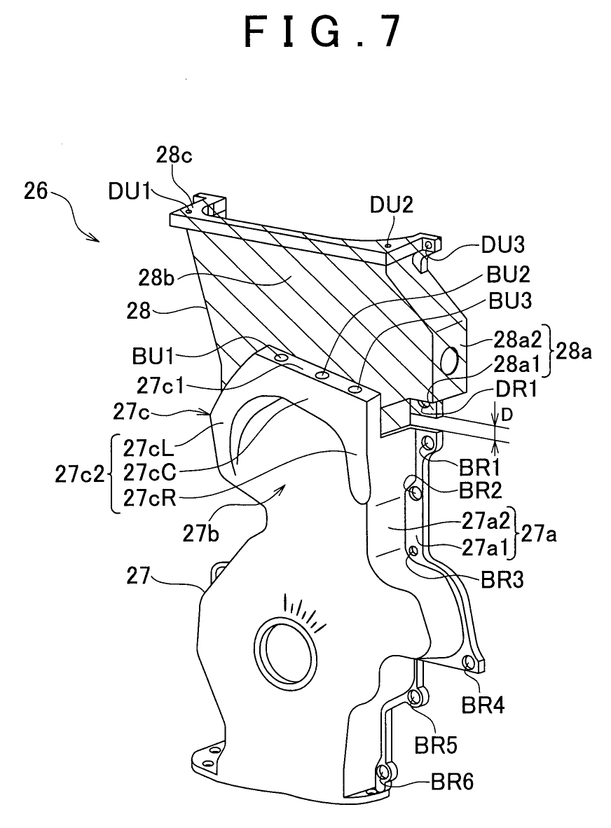

As shown in the perspective views of the chain case 26 in FIGS. 6 and 7, the chain case 26 is made up of a crankcase-side chain case (lower-side chain case) 27, and a cylinder block-side chain case (upper-side chain case) 28. Incidentally, in FIGS. 6 and 7, the cylinder block-side chain case 28 is marked with diagonal lines to facilitate distinction thereof. FIG. 6 shows an instance where the aforementioned distance D is set at the minimum distance, and therefore the compression ratio of the internal combustion engine 20 is set at a highest compression ratio. FIG. 7 shows an instance where the aforementioned distance D is set at a maximum distance, and therefore the compression ratio of the internal combustion engine 20 is set at a lowest compression ratio.

The crankcase-side chain case 27 has side wall portions 27a, a front wall portion 27b, and a support member coupling portion 27c. In this embodiment, these portions are integrally formed by casting.

The side wall portions 27a are made up of flanges 27a1 and side walls 27a2. The flanges 27a1 have a predetermined width, and are provided on left and right end portions of the crankcase-side chain case 27. Each flange 27a1 constitutes a portion provided for fixing the crankcase-side chain case 27 to the front surface Pf of the crankcase 21 (a forward wall of the crankcase 21 constituting the front surface Pf). The shapes of the outer peripheries of the flanges 27a1 located on the left and right sides of the crankcase-side chain case 27 are such as to extend along the left and right end portions of the front surface Pf of the crankcase 21. The flange 27a1 located on the right side of the crankcase-side chain case 27 has a plurality of bolt holes BR1 to BR6. The flange 27a1 located on the left side of the crankcase-side chain case 27, which is not shown in FIG. 6 or 7, also has a plurality of bolt holes BL1 to BL6 (not shown). When the crankcase-side chain case 27 is fixed to the front surface Pf of the crankcase 21, a plane defined by the flanges 27a1 becomes parallel to the front surface Pf of the crankcase 21, and the flanges 27a1 contact the front surface Pf of the crankcase 21.

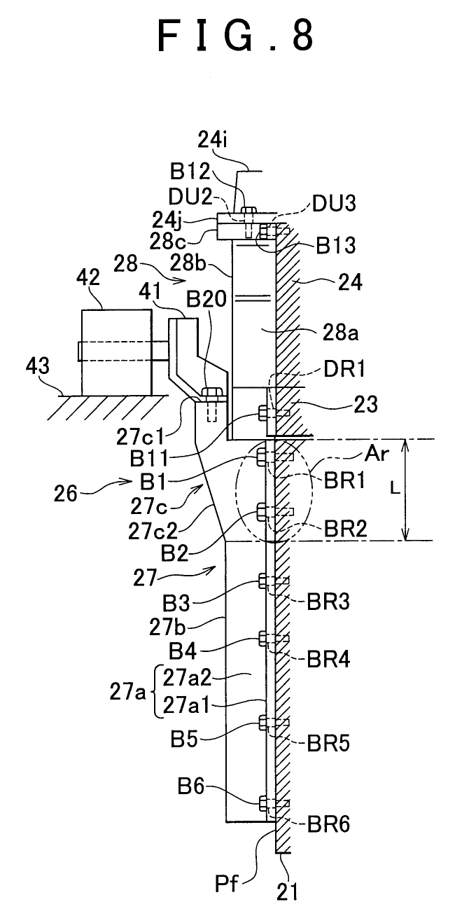

The side walls 27a2 are platy portions that constitute the left and right side walls of the crankcase-side chain case 27. The side wall 27a2 located on the right side of the crankcase-side chain case 27 is contiguous to an inner periphery-side end portion of the flange 27a1 located on the right side of the crankcase-side chain case 27. Likewise, the side wall 27a2 located on the left side of the crankcase-side chain case 27 is contiguous with an inner periphery-side end portion of the flange 27a1 located on the left side of the crankcase-side chain case 27. The left and right side walls 27a2 extend (are provided so as to stand upright) from the front surface Pf of the crankcase 21 in a direction substantially orthogonal to the front surface Pf of the crankcase 21 when the crankcase-side chain case 27 is fixed to the front surface Pf of the crankcase 21. From the above description, it can be said that the side wall portions 27a located on the left and right sides of the crankcase 21 contact a left-side end-adjacent portion and a right-side end-adjacent portion, respectively, of the front surface Pf of the crankcase 21, and extend in a direction orthogonal to the front surface Pf of the crankcase 21. Upper ends of the left and right side walls 27a2 are formed so as to be located in substantially the same plane as an upper end surface of the crankcase 21 when the crankcase-side chain case 27 is fixed to the front surface Pf of the crankcase 21 as shown in FIG. 1, and FIG. 8, which will be described.

The front wall portion 27b is a platy portion (a substantially flat platy member in this embodiment) that constitutes a front surface wall of the crankcase-side chain case 27. The front wall portion 27b couples the side wall 27a2 located on the left side and the side wall 27a2 located on the right side. The plane defined by the front wall portion 27b faces and is substantially parallel to the front surface Pf of the crankcase 21 when the crankcase-side chain case 27 is fixed to the front surface Pf of the crankcase 21.

The support member coupling portion 27c has a support member fixture portion 27c1 and a rib 27c2. The support member fixture portion 27c1 is a portion that constitutes an upper wall (upper plane) of the support member coupling portion 27c when the crankcase-side chain case 27 is fixed to the front surface Pf of the crankcase 21. The support member fixture portion 27c1 is located above an upper end of the side wall portion 27a. Therefore, the support member fixture portion 27c1 is located above the upper end of the crankcase 21 when the crankcase-side chain case 27 is fixed to the front surface Pf of the crankcase 21. The support member fixture portion 27c1 has a plurality of (three in this embodiment) holt holes BU1 to BU3 for fixing an engine mount bracket (support member) 41 shown in FIGS. 1 and 8.

The rib 27c2 is made up of a middle portion 27cC that is contiguous to the support member fixture portion 27c1 and that extends in a substantially horizontal direction so as to be along the support member fixture portion 27c1 when the crankcase-side chain case 27 is fixed to the front surface Pf of the crankcase 21, a right-side leg portion 27cR that extends downward from a vicinity of a right end portion of the middle portion 27cC (i.e., a vicinity of a right end portion of the support member fixture portion 27c1), and a left-side leg portion 27cL that extends downward from a vicinity of a left end portion of the middle portion 27cC (i.e., a vicinity of a left end portion of the support member fixture portion 27c1). That is, the shape of the rib 27c2 is an inverted “U” shape (a shape of two legs joined) in a front view. The rib 27c2 is formed so as to extend from the support member fixture portion 27c1 to a portion (upper portion) of the side wall portion 27a, thus improving the rigidity of the front wall portion 27b. That is, the right leg portion 27cR and the left leg portion 27cL extend from the middle portion 27cC to upper portions of the side wall portions 27a. Therefore, the rib 27c2 is contiguous to the support member fixture portion 27c1, and extends to reach an end portion of each of the side wall portions 27a that is a portion (upper portion) of the side wall portion 27a and that is opposite from a portion of the side wall portion 27a that is in contact with the crankcase 21. Thus, the rib 27c2 constitutes a reinforcement portion that improves the rigidity of the front wall portion 27b against the force that is in the direction orthogonal to the front surface Pf of the crankcase 21 (prevents bending deformation of the front wall portion 27b.

The rib 27c2, as shown in FIG. 8, reaches a position that is a distance L downward from the upper end of the side wall portion 27a. For the sake of convenience, the region where the rib 27c2 reaches the side wall portion 27a (side wall 27a2) will be termed “rib reach region”. Therefore, a region in the side wall portion 27a (side walls 27a2) where the rib 27c2 does not reach will be termed as “rib non-reach region”.

As shown in FIGS. 6 to 8, a bolt hole BR1 and a bolt hole BR2 are formed in a portion of the right-side flange 27a1 (in a region Ar in FIG. 8) that is contiguous to the portion of the side wall 27a2 that extends from the aforementioned rib reach region in the direction orthogonal to the front surface Pf of the crankcase 21. A bolt hole BL1 and a bolt hole BL2 (not shown) are also formed at similar positions in the left-side flange 27a1.

Bolt holes BR3 to BR6 are formed in a portion of the right-side flange 27a1 (in a region other than the region Ar in FIG. 8) that is contiguous to a portion of the side wall 27a2 that extends from the aforementioned rib non-reach region in the direction orthogonal to the front surface Pf of the crankcase 21. Bolt holes BL3 to BL6 (not shown) are also formed at similar positions in the left-side flange 27a1.

The crankcase-side chain case 27 constructed as described above is bolted to the front surface Pf of the crankcase 21 as shown in FIG. 8, that is, by the bolts B1 to B6 inserted through the bolt holes BR1 to BR6 that are formed in the flange 27a1 located on the right side of the crankcase-side chain case 27, and is also bolted to the front surface Pf of the crankcase 21 by the bolts B1 to B6 inserted through the bolt holes BL1 to BL6 formed in the flange 27a1 (not shown) located on the left side of the crankcase-side chain case 27.

The bolt B1 used in the bolt hole BR1 (and the bolt hole BL1) and the bolt B2 used in the bolt hole BR2 (and the bolt hole BL2) are identical to each other. The bolt B1 and the bolt B2 are termed the first bolts, for the sake of convenience. The bolts B3 to B6 used in the other bolt holes BR3 to BR6 (and the bolt holes BL3 to BL6) are also identical to one another. The bolts B3 to B6 are termed the second bolts, for the sake of convenience. The diameter of the first bolts is larger than the diameter of the second bolts. For example, the diameter of the first bolt is 8 mm, whereas the diameter of the second bolt is 6 mm. In addition, a lower end portion of the crankcase-side chain case 27 has a flange in which an oil pan-fastening bolt hole is formed. The crankcase-side chain case 27 is fastened to the oil pan 22 by a bolt inserted through the oil pan-fastening bolt hole.

The cylinder block-side chain case 28 has platy side wall portions 28a, a front wall portion 28b, and an upper surface portion 28c.

Each side wall portion 28a is made up of a flange portion 28a1 and a side wall portion 28a2.

Each flange portion 28a1 is formed of a thin plate having a predetermined width and a predetermined thickness. Each flange portion 28a1 constitutes a portion for fixing the cylinder block-side chain case 28 to the front surface Pf side of the cylinder block 23 (in reality, to a forward wall Pf′ located most forward on the cylinder block 23 which constitutes the front surface Pf). The flange portions 28a1 are provided on the left and right sides of a lower end portion of the cylinder block-side chain case 28. The outer peripheral shape of each of the left and right flange portions 28a1 is such as to extend along a corresponding one of the left and right end portions of a lower end portion of the front surface Pf of the cylinder block 23. The flange portion 28a1 located on the right side of the cylinder block-side chain case 28 has a bolt hole DR1. The flange portion 28a1 located on the left side of the cylinder block-side chain case 28 (which is not shown in any of FIGS. 6 to 8) also has a bolt hole DL1 (not shown). When the cylinder block-side chain case 28 is fixed to the front surface Pf side of the cylinder block 23, the plane defined by the flange portions 28a1 becomes parallel to the front surface Pf of the cylinder block 23, and the flange portions 28a1 contact the forward wall Pf′ of the cylinder block 23.

The side wall portions 28a2 are platy portions that constitute side walls of the cylinder block-side chain case 28. A lower portion of the side wall portion 28a2 located on the right side of the cylinder block-side chain case 28 is contiguous to an inner periphery-side end portion of the flange portion 28a1 located on the right side of the cylinder block-side chain case 28. Likewise, a lower portion of the side wall portion 28a2 located on the left side of the cylinder block-side chain case 28 is contiguous to an inner periphery-side end portion of the flange portion 28a1 located on the left side of the cylinder block-side chain case 28. A lower portion of each of the left and right side wall portions 28a2 extends (is provided so as to stand upright) from the inner periphery-side end portion of the flange portion 28a1 in a direction substantially orthogonal to the front surface Pf of the cylinder block 23 when the cylinder block-side chain case 28 is fixed to the front surface Pf side of the cylinder block 23.

An upper portion of each of the left and right side wall portions 28a2 extends (is provided so as to stand upright) from a vicinity of a corresponding one of left and right outer periphery portions of the front surfaces Pf of the cylinder block 23 and the cylinder head portion 24 in a direction substantially orthogonal to the front surfaces Pf of the cylinder block 23 and the cylinder head portion 24, when the cylinder block-side chain case 28 is fixed to the front surface Pf side of the cylinder block 23. An upper end of each of the left and right side wall portions 28a2 is at a position that is slightly lower than the upper end surface of the cylinder head portion 24 when the cylinder block-side chain case 28 is fixed to the front surface Pf side of the cylinder block 23.

The front wall portion 28b is a platy portion that constitutes a front surface wall of the cylinder block-side chain case 28. The front wall portion 28b couples the side wall portion 28a2 located on the left side and the side wall portion 28a2 located on the right side. Therefore, the plane defined by the front wall portion 28b faces and is substantially parallel to the front surfaces Pf of the cylinder block 23 and the cylinder head portion 24 when the cylinder block-side chain case 28 is fixed to the front surface Pf of the cylinder block 23. An upper end of the front wall portion 28b is at a position that is slightly lower than the upper end surface of the cylinder head portion 24 when the cylinder block-side chain case 28 is fixed to the front surface Pf side of the cylinder block 23.

The upper surface portion 28c is a flange that is formed on the upper end portions of the platy side wall portions 28a and the front wall portion 28b. An upper flat surface of the upper surface portion 28c has a plurality of (two in this example) bolt holes DU1, DU2 for fixing the cylinder block-side chain case 28 and the cylinder head cover 24i to each other. In other words, the upper surface portion 28c is provided with a cylinder head cover coupling portion for coupling the upper surface portion 28c to the cylinder head cover 24i. Furthermore, left and right-end side flat surfaces (front surfaces) of the upper surface portion 28c have a plurality of (two in this embodiment) bolt holes DU3 and DU4 (DU4 being not shown in any of FIGS. 6 to 8) for fixing the cylinder block-side chain case 28 to the cylinder head portion 24.

The cylinder block-side chain case 28 constructed as described above is bolted to the forward wall Pf′ of the cylinder block 23 as shown in FIG. 8, that is, by a bolt 11 inserted through the bolt hole DR1 formed in the flange portion 28a1 located on the right side of the cylinder block-side chain case 28, and is also bolted to the forward wall Pf′ of the cylinder block 23 by a bolt B11 inserted through the bolt DL1 (not shown) formed in the flange portion 28a1 located on the left side of the cylinder block-side chain case 28.

Furthermore, the cylinder block-side chain case 28 is fixed to the cylinder head cover 24i by bolts B12 inserted into the bolt holes DU1, DU2 of the upper surface portion 28c and bolt holes formed in a flange 24j of the cylinder head cover 24i. Moreover, the cylinder block-side chain case 28 is bolted to the front surface Pf of the cylinder head portion 24 by bolts B13 inserted through the bolt hole DU (and the bolt hole DU4 (not shown)) of the upper surface portion 28c. The bolts B11 to B13 (the bolts that fix the cylinder block-side chain case 28 to the front surface Pf or the like of the cylinder block 23) are the aforementioned second bolts.

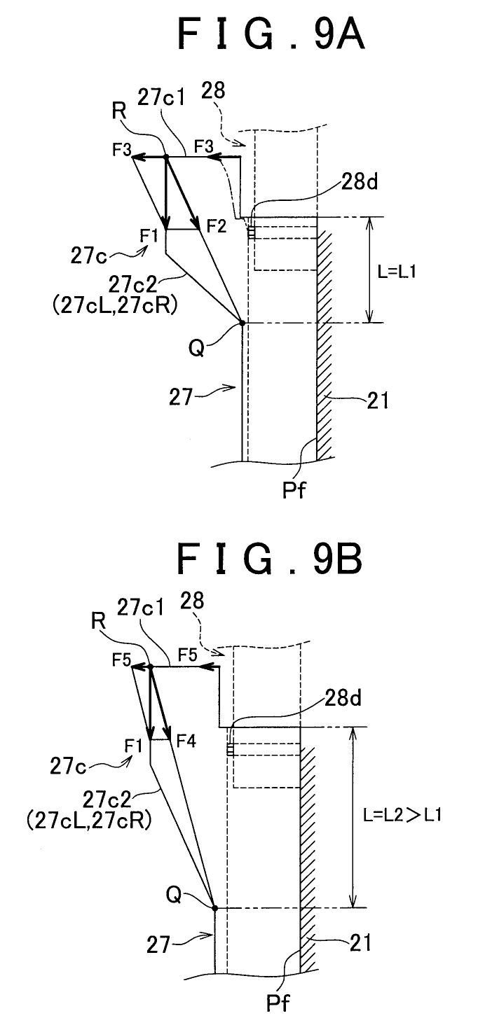

As shown in FIGS. 9A and 9B, a lower portion of the cylinder block-side chain case 28 enters the inside of the crankcase-side chain case 27 fixed to the front surface Pf of the crankcase 21 (a space defined by a reverse surface of the crankcase-side chain case 27, reverse surfaces of the side walls 27a, and the front surface Pf of the crankcase 21). A seal member 28d is disposed on and fixed to a lower portion of the cylinder block-side chain case 28. The seal member 28d seals a gap or the like between the cylinder block-side chain case 28 and the crankcase-side chain case 27. When the compression ratio is changed, the seal member 28d slides relative to the reverse surface of the front wall portion 27b and the reverse surfaces of the side walls 27a of the crankcase-side chain case 27 to maintain oil tightness of the interior of the chain case 26.

As shown in FIGS. 1 and 8, a portion of an engine mount bracket 41 is supported by an engine mount member (engine mount insulator) 42 that is fixed to a vehicle body 43. The engine mount member 42 includes a well-known vibration damper member that is made up of a liquid-tight member, an elastic member, etc. Other portions of the engine mount bracket 41 are fixed, as shown in FIGS. 6 to 8, to the support member fixture portion 27c1 by bolts B20 inserted into the bolt holes BU1 to BU3 formed in the support member fixture portion 27c1 of the crankcase-side chain case 27. As a result, the crankcase 21 is supported via the engine mount member 42, the engine mount bracket 41, and the crankcase-side chain case 27 in such a manner as to be suspended from the vehicle body 43.

The transmission device 30 is a device for changing the output torque of the internal combustion engine 20 to the rotating torque of wheels (not shown), and is made up of well-known structure bodies such as a transmission that includes a torque converter coupled to the crankshaft 21a, a differential gear, etc. The transmission device 30 is supported, as shown in FIG. 1, by a transmission device support member 44 in such a manner as to be suspended from the vehicle body 43. Therefore, the drive device 10 is supported at a point P1 (first position) shown in FIG. 1 by the vehicle body 43 via the engine mount bracket 41 and the engine mount member 42, and is also supported at a point P2 (second position) by the vehicle body 43 via the transmission device support member 44.

The point P1 and the point P2 are set so that a straight line connecting between the point P1 and the point P2 (hereinafter, referred to as “mount axis MTL”) forms the principal axis of inertia of the drive device 10. The principal axis of inertia is a rotation axis that minimizes the inertia moment of the drive device 10. Therefore, even if vibration with its rotation center being on the mount axis MTL occurs due to rotation of the crankshaft 21a or the like involved in the operation of the internal combustion engine 20, the vibration of the vehicle caused by the vibration about the mount axis MTL is restrained since the mount axis MTL coincides with the principal axis of inertia.

The mount axis MTL is set so that the center of gravity G of a structure body made up of the crankcase 21, the oil pan 22, the crankcase-side chain case 27, the transmission device 30, etc. (i.e., a structure body obtained by excluding from the drive device 10 the structure bodies that are moved to change the compression ratio, that is, the cylinder block 23, the cylinder head portion 24, the cylinder block-side chain case 28, etc., which will be referred to as “non-mobile portion”) is below the mount axis MTL.

Therefore, the non-mobile portion can be stably supported, and therefore the entire drive device 10 that includes the crankcase 21 can be stably supported, in comparison with the instance where the center of gravity of a non-mobile portion having a large weight is above the mount axis MTL. Besides, since the mount axis MTL coincides with the principal axis of inertia, the inertia moment of the non-mobile portion becomes large, so that the non-mobile portion can be more stably supported. Therefore, the internal combustion engine 20 that includes a structure body (i.e., the cylinder block 23, the cylinder head portion 24, etc.) provided in an upper portion of the non-mobile portion (which is therefore the drive device 10) can be stably supported. As a result, the force exerted from the vehicle body to the crankcase-side chain case 27 can be lessened, so that the deformation of the crankcase-side chain case 27 can be more effectively restrained.

As described above, the drive device 10 includes the support members 41, 42 that are partially supported on the vehicle body 43 in order to support the drive device 10 onto the vehicle body 43, the cylinder block-side chain case 28 which is fixed to the cylinder block 23 that is disposed above the crankcase 21 and that is moved in the direction of the cylinder axes CC, in such a manner that the cylinder block-side chain case 28 covers the front surface Pf of the cylinder block 23, and the crankcase-side chain case 27 that is fixed to the crankcase 21 so as to cover the front surface Pf of the crankcase 21 and that has the support member coupling portion 27c (a portion that includes the bolt holes BU1 to BU3) that couples other portions of the support members 41, 42.

Therefore, when the compression ratio of the internal combustion engine 20 is changed, the cylinder block 23 (and the cylinder head portion 24, and the like) that is comparatively light in weight is moved in the up-down direction relative to the comparatively heavy non-mobile portion that includes the crankcase 21 and the structure body (the transmission device 30, and the like) coupled to the crankcase and that is supported on or fixed to the vehicle body. As a result, the energy needed in order to change the compression ratio (e.g., the energy consumed by the motor that rotates the shaft-shaped drive portion 25c described above) can be reduced.

The crankcase-side chain case 27 has the side wall portions 27a that contact a vicinity of a left-side end portion and a vicinity of a right-side end portion of the front surface Pf of the crankcase 21 and that extend in a direction orthogonal to the front surface Pf of the crankcase 21, and the front wall portion 27b that is contiguous to the side wall portion 27a and that faces the front surface Pf of the crankcase 21. Furthermore, the support member coupling portion 27c includes the support member fixture portion 27c1 which another portion of the support member 41 contacts and is fixed to, and ribs 27cL, 27cR that extend from the support member fixture portion 27c1 and that are contiguous to the front wall portion 27b so as to improve the rigidity of the front wall portion 27b (in particular, the rigidly of the front wall portion 27b against the force acting in a direction orthogonal to the plane defined by the front wall portion 27b). Therefore, deformation of the front wall portion 27b can be prevented.

Furthermore, the ribs (ribs' leg portions) 27cL, 27cR are formed so as to extend from the support member fixture portion 27c1 to portions of the side wall portions 27a. Therefore, a great force (component force) exerted on the support member fixture portion in the direction orthogonal to the front surface of the crankcase is transmitted to portions of the side wall portions 27a (portions of the side wall portions 27a that are present in the rib-reach regions) through the ribs 27cL, 27cR. The side wall portions 27a are in contact with the front surface Pf of the crankcase 21, and extend in the direction orthogonal to the front surface Pf of the crankcase 21. Therefore, each side wall portion 27a does not deform under the great force in the direction orthogonal to the front surface Pf of the crankcase 21 which is transmitted thereto through the ribs 27cL, 27cR, but transmits the force to the front surface Pf of the crankcase 21. In consequence, deformation of the crankcase-side chain case 27 (in particular, the front wall portion 27b) can be prevented.

Furthermore, the support member fixture portion 27c1 is disposed above the upper ends of the side wall portions 27a, and the first bolt-purpose seat surfaces (bolt holes BR1, BR2, BL1, BL2) are formed in portions of the side wall portions 27a that extend from the rib-reach regions in the direction orthogonal to the front surface Pf of the crankcase 21 and that contact the front surface Pf of the crankcase 21. Therefore, the great force exerted on the support member fixture portion 27c1 in the direction orthogonal to the front surface Pf of the crankcase 21 is more reliably transmitted to the front surface Pf of the crankcase 21 by the ribs 27cL, 27cR, the side wall portions 27a and the first bolts B1, B2. In consequence, deformation of the front wall portion 27b of the crankcase-side chain case 27 can be more reliably prevented.

In addition, the second bolt-purpose seat surfaces (bolt holes BR3 to BR6, BL3 to BL6) are formed in other portions of the side wall portions 27a that extend from the rib non-reach regions where the rib 27cL or 27cR does not reach the side wall portion 27a, in the direction orthogonal to the front surface Pf of the crankcase 21, and that contact the front surface Pf of the crankcase 21, and the diameter of the second bolts B3 to B6 used in the second bolt-purpose seat surfaces is smaller than the diameter of the first bolts B1, B2. Therefore, while the number of heavy-weight and large-diameter bolts (first bolts) is reduced, the rigidity, the fastening force and the like of the crankcase-side chain case 27 at the fastening sites between the crankcase-side chain case 27 and the crankcase 21 can be set at needed values, and the weight of the internal combustion engine can be reduced.

Incidentally, as for the length of the rib 27c2 measured from the upper end of the crankcase-side chain case 27 (i.e., the length of each of the leg portions 27cR, 27cL of the rib 27c2, which will be simply referred to as “rib leg length”), greater lengths are advantageous in various respects. This will be described hereinafter with reference to FIGS. 9A and 9B. FIG. 9A shows a instance where the rib leg length is relatively short. The rib leg length can be expressed by the distance L from the upper ends of the side wall portions 27a to a point Q at which the rib disappears. In the crankcase-side chain case 27 shown in FIG. 9A, the distance L=L1.

In FIG. 9A, a downward force F1 is input to the crankcase-side chain case 27 via a support member. The force F1 is divided into a force F2 in a direction from a portion (point R) of contiguity between the support member fixture portion 27c1 and the rib 27c2 toward the point Q, and a force F3 in the direction orthogonal to the front surface Pf of the crankcase 21. The force F3 is a force that urges the upper end portion of the crankcase-side chain case 27 in a direction away from the front surface Pf of the crankcase 21. As a result, there is a possibility that an upper portion of the crankcase-side chain case 27 may deform as shown by a one-dot chain line, and that the sealing characteristic of the seal member 28d may decline.

On the other hand, the rib 27c2 shown in FIG. 9B has relatively long legs. That is, the distance L=L2, and the distance L2 is longer than the distance L1. In this instance, the downward force F1 input to the crankcase-side chain case 27 via the support member is divided into a force F4 in a direction from the point R to the point Q, and a force F5 in the direction orthogonal to the front surface Pf of the crankcase 21. This force F5 is a force that urges an upper end portion of the crankcase-side chain case 27 in a direction away from the front surface Pf of the crankcase 21. However, as can be understood from the comparison between FIG. 9A and FIG. 9B, the force F5 is smaller than the force F3. Therefore, the greater the rib leg length, the less likely the upper portion of the crankcase-side chain case 27 is to deform.

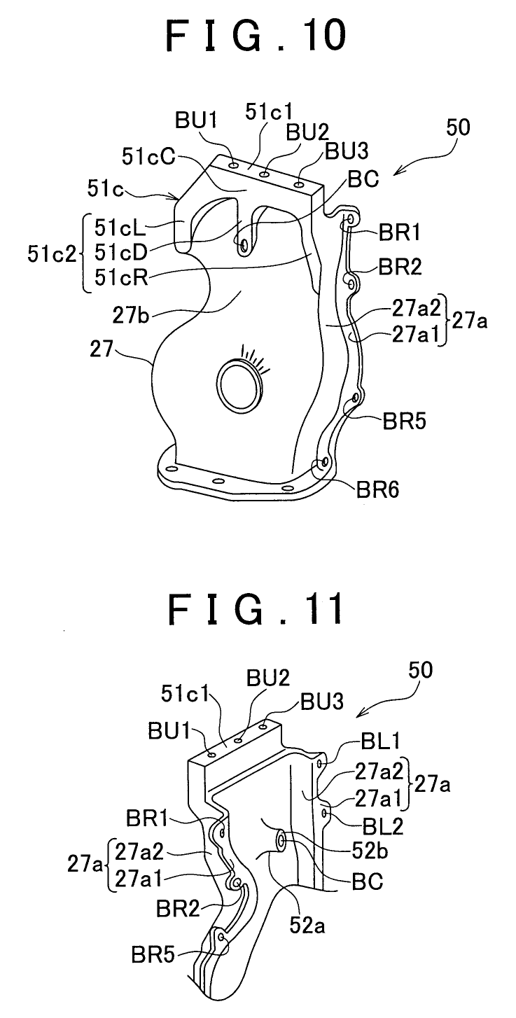

If the distance L is long, the length of the rib-reach regions is also long, so that many bolt holes (bolt seat surfaces) can be formed in the flanges 27a1 present within the regions Ar shown in FIG. 8; thus, many bolt-fastened portions can be provided in portions where great force acts. This further improves the rigidity of the upper end portion of the crankcase-side chain case 27, and more thoroughly avoids deformation of the crankcase-side chain case 27.

<FIRST MODIFICATION> Next, a first modification of the crankcase-side chain case in accordance with the invention will be described with reference to FIGS. 10 and 11. In FIGS. 10 and 11, substantially the same portions as those provided in the crankcase-side chain case 27 described above are represented by the same reference characters, and the description thereof will be omitted below.

A crankcase-side chain case 50 in accordance with this modification has a support member coupling portion 51c instead of the support member coupling portion 27c of the crankcase-side chain case 27, as shown in FIG. 10, which is an obverse surface side perspective view. The support member coupling portion 51c includes a support member fixture portion 51c1 that is identical to the support member fixture portion 27c1, and a rib 51c2 instead of the rib 27c2.

The rib 51c2 includes a middle portion 51cC, a right-side leg portion 51cR and a left-side leg portion 51cL that are identical to the middle portion 27cC, the right-side leg portion 27cR and the left-side leg portion 27cL, respectively. Furthermore, the rib 51c2 also includes a middle downward extended portion 51cD that extends downward from a substantially middle portion of the middle portion 51cC with respect to the left-right direction (an intermediate portion between the leg portion 27cL and the leg portion 27cR). A lower end of the middle downward extended portion 51cD is extended to substantially the same position as lower ends of the right-side leg portion 51cR and the left-side leg portion 51cL (a position below an upper ends of side wall portions 27a), and is contiguous with a front wall portion 27b.

FIG. 11 is a perspective view of the crankcase-side chain case 50 viewed from the reverse surface side of the crankcase-side chain case 50. As shown in FIG. 11, the rib 51c2 includes an extended-out portion (protruded portion) 52a that is extended out (protruded) from a site near a lower end portion of the middle downward extended portion 51cD, toward the front face of the crankcase. A distal end of the extended-out portion 52a has a flat surface-shaped top portion 52b. The flat surface formed by the top portion 52b is parallel to the front surface Pf of the crankcase 21 and is in contact with the front surface Pf of the crankcase 21 when the crankcase-side chain case 50 is fixed to the front surface Pf of the crankcase 21. The top portion 52b has a bolt hole BC dedicated to a third bolt (therefore, a third bolt-purpose seat surface) that is provided for fixing the crankcase-side chain case 50 to the crankcase 21. The third bolt that uses the third bolt-purpose seat surface is equal in diameter to the aforementioned first bolts B1, B2. Incidentally, the extended-out portion 52a is provided at such a position as not to interfere with a chain mechanism (not shown).

The crankcase-side chain case 50 is bolted to the front surface Pf of the crankcase 21 by a plurality of bolts B1, B2, B5 and B6 inserted through bolt holes BR1, BR2, BR5 and BR6, respectively, which are formed in the flange 27a1 located on the right side of the crankcase-side chain case 27, and is also bolted to the front surface Pf of the crankcase 21 by a plurality of bolts B1, B2, B5 and B6 inserted through bolt holes BL1, BL2, BL5 and BL6, respectively, which are formed in the flange 27a1 located on the left side of the crankcase-side chain case 27. Incidentally, the bolt hole BR1 and the bolt hole BR2 are formed in a portion of the right-side flange 27a1 that is contiguous to a portion of the side walls 27a2 that extends from the aforementioned rib-reach region in the direction orthogonal to the front surface Pf of the crankcase 21. The bolt hole BL1 and the bolt hole BL2 (which are not shown) are formed at positions similarly determined on the left side of the crankcase-side chain case 50. Furthermore, the crankcase-side chain case 50 is bolted to the front surface Pf of the crankcase 21 by the third bolt inserted through the third bolt-purpose bolt hole BC that is formed in the top portion 52b of the extended-out portion 52a. The diameter of the third bolt is the same as the diameter of the first bolts (bolts B1, B2), and is larger than the diameter of the second bolts (B5, B6).

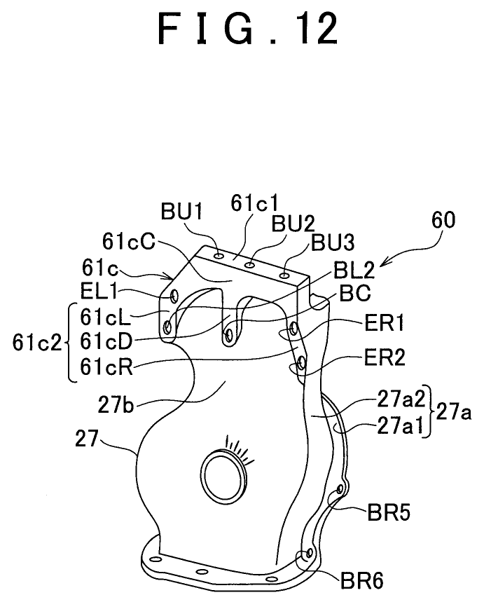

Therefore, a great component force exerted on the front wall portion 27b in the direction orthogonal to the front surface of the crankcase can be transmitted to front surface Pf of the crankcase 21 through the rib 51c2, the side wall portions 27a, and the extended-out portion 52a protruded from the rib 51c2. In consequence, deformation of the front wall portion 27b of the crankcase-side chain case 50 can be more reliably prevented.

<SECOND MODIFICATION> Next, a second modification of the crankcase in accordance with the invention will be described with reference to FIG. 12. In FIG. 12, substantially the same portions as those provided in the crankcase-side chain case 27 are represented by the same reference characters, and the description thereof will be omitted below.

A crankcase-side chain case 60 in accordance with the second modification includes a support member coupling portion 61c instead of the support member coupling portion 27c of the crankcase-side chain case 27. The support member coupling portion 61c includes a support member fixture portion 61c1 identical to the support member fixture portion 27c1, and a rib 61c2 instead of the rib 27c2.

The rib 61c2 includes a middle portion 61cC, a right-side leg portion 61cR, a left-side leg portion 61cL, and a middle downward extended portion 61cD. The middle portion 61cC and the middle downward extended portion 61cD are substantially the same as the middle portion 51cC and the middle downward extended portion 51cD of the first modification.

The right-side leg portion 61cR extends downward from a right end portion of the middle portion 61cC. A side surface of the right-side leg portion 61cR (that is the side surface on the same side as plane formed by a right-side side wall 27a2) is contiguous to the right-side side wall 27a2, and forms a right-side side wall of an upper portion of the crankcase-side chain case 60. The right-side leg portion 61cR extends out toward the front surface Pf of the crankcase 21, and contacts the front surface Pf of the crankcase 21. A contact portion of the right-side leg portion 61cR with the front surface Pf of the crankcase 21 has first bolt-purpose seat surfaces. The right-side leg portion 61cR has two bolt holes ER1, ER2 into which bolts that use the first bolt-purpose seat surfaces are inserted. The positions of the bolt holes ER1, ER2 with respect to the front surface Pf of the crankcase 21 are the same as the positions of the bolt holes BR1, BR2 with respect to the front surface Pf of the crankcase 21.

The left-side leg portion 61cL extends downward from a left end portion of the middle portion 61cC. A side surface of the left-side leg portion 61cL (that is the side surface on the same side as the plane formed by the left-side side wall 27a2) is contiguous to the left-side side wall 27a2, and forms a left-side side wall of an upper portion of the crankcase-side chain case 60. The left-side leg portion 61cL extends out toward the front surface Pf of the crankcase 21, and contacts the front surface Pf of the crankcase 21. A contact portion of the left-side leg portion 61cL with the front surface Pf of the crankcase 21 has a first bolt-purpose seat surface. The left-side leg portion 61cL as two bolt holes EL1, EL2 through which bolts that use the first bolt-purpose seat surfaces are inserted. The positions of the bolt holes EL1, EL2 with respect to the front surface Pf of the crankcase 21 are the same as the positions of the bolt holes BL1, BL2 with respect to the front surface Pf of the crankcase 21.

The crankcase-side chain case 60 is bolted to the front surface Pf of the crankcase 21 by second bolts inserted through the bolt holes BR5, BR6, BL5 and BL6 formed in the left and right flanges 27a1, and is also bolted to the front surface Pf of the crankcase 21 by a third bolt inserted through the third bolt-purpose bolt hole BC formed in an extended-out portion extending from the middle downward extended portion 61cD. Furthermore, the crankcase-side chain case 60 is bolted to the front surface Pf of the crankcase 21 by third bolts that use the first bolt-purpose seat surfaces and the bolt holes ER1, ER2 formed in the right-side leg portion 61cR, or the first bolt-purpose seat surfaces and the bolt holes EL1, EL2 formed in the left-side leg portion 61cL.

According to this modification, the right-side leg portion 61cR and the left-side leg portion 61cL of the rib 62c2 constitute portions of the side wall portions of the crankcase-side chain case 60, and the leg portions 61cR, 61cL are bolted to the front surface Pf of the crankcase 21, at portions of the leg portions 61cR, 61cL that are in contact with the front surface Pf of the crankcase 21. Therefore, great component force that would act on the front wall portion 27b in the direction orthogonal to the front surface of the crankcase can be transmitted directly to the front surface Pf of the crankcase 21 through the right-side leg portion 61cR and the left-side leg portion 61cL of the rib 62c2. In consequence, deformation of the front wall portion 27b of the crankcase-side chain case 60 can be more reliably prevented.

As described above, the drive device 10 in accordance with the embodiments of the invention can make it possible to appropriately mount the internal combustion engine 20 in the vehicle body, and can prevent various faults caused by deformation of the divided chain case 26. Incidentally, the invention is not limited to the foregoing embodiments, but various modifications may be adopted within the scope of the invention.

What is claimed is:

1. A drive device mounted in a vehicle body, comprising:
a transmission device;
a variable compression ratio internal combustion engine that includes a crankcase that rotatably supports a crankshaft coupled to the transmission device, and a cylinder block disposed above the crankcase, and that is capable of changing a compression ratio by moving the cylinder block relative to the crankcase in a cylinder axis direction;
a support member whose portion is supported on the vehicle body in order to support the drive device on the vehicle body;
a cylinder block-side chain case fixed to the cylinder block so as to cover a front surface of the cylinder block that is a surface opposite from a side of the cylinder block where the transmission device is disposed; and
a crankcase-side chain case which is fixed to the crankcase so as to cover a front surface of the crankcase that is a surface opposite from a side of the crankcase where the transmission device disposed, and which has a support member coupling portion that couples to another portion of the support member.

2. The drive device according to claim 1,
wherein the crankcase-side chain case has:
a side wall portion that contacts a vicinity of a left-side end portion of the front surface of the crankcase and a vicinity of a right-side end portion of the front surface of the crankcase and that extends in a direction orthogonal to the front surface of the crankcase; and
a front wall portion that is contiguous to the side wall portion and that faces the front surface of the crankcase, and
wherein the support member coupling portion includes a support member fixture portion which another portion of the support member is in contact with and is fixed to, and which forms an upper wall of the support member coupling portion, and a rib that extends from the support member fixture portion and that is contiguous to the front wall portion so as to improve a rigidity of the front wall portion.

3. The drive device according to claim 2, wherein the rib is formed so as to extend from the support member fixture portion to a portion of the side wall portion.

4. The drive device according to claim 3, wherein a first bolt-purpose seat surface for fixing the crankcase-side chain case and the crankcase to each other is formed in a portion of the side wall portion that extends from a rib-reach region that is a region in the side wall portion in which the rib reaches the side wall portion, in the direction orthogonal to the front surface of the crankcase, and that contacts the front surface of the crankcase.

5. The drive device according to claim 4, wherein a second bolt-purpose seat surface for fixing the crankcase-side chain case and the crankcase to each other is formed in another portion of the side wall portion that extends from a rib non-reach region that is another region in the side wall portion in which the rib does not reach the side wall portion, in the direction orthogonal to the front surface of the crankcase, and a diameter of a second bolt that uses the second bolt-purpose seat surface is smaller than a diameter of a first bolt that uses the first bolt-purpose seat surface.

6. The drive device according to claim 2, wherein at least a portion of the rib includes an extended-out portion that is extended out so as to contact the front surface of the crankcase, and a third bolt-purpose seat surface for fixing the crankcase-side chain case and the crankcase to each other is formed in the extended-out portion.

7. The drive device according to claim 3, wherein at least a portion of the rib includes an extended-out portion that is extended out so as to contact the front surface of the crankcase, and a third bolt-purpose seat surface for fixing the crankcase-side chain case and the crankcase to each other is formed in the extended-out portion.

8. The drive device according to claim 4, wherein at least a portion of the rib includes an extended-out portion that is extended out so as to contact the front surface of the crankcase, and a third bolt-purpose seat surface for fixing the crankcase-side chain case and the crankcase to each other is formed in the extended-out portion.

9. The drive device according to claim 5, wherein at least a portion of the rib includes an extended-out portion that is extended out so as to contact the front surface of the crankcase, and a third bolt-purpose seat surface for fixing the crankcase-side chain case and the crankcase to each other is formed in the extended-out portion.

10. The drive device according to claim 9, wherein a diameter of a third bolt that uses the third bolt-purpose seat surface is larger than a diameter of the second bolt that uses the second bolt-purpose seat surface.

11. The drive device according to claim 1, wherein the portion of the support member that is supported on the vehicle body is supported on the vehicle body at a first position that is above an upper end of the crankcase, and the transmission device is supported on the vehicle body at a second position, and the first position is set at such a position that a center of gravity of a structure body of the drive device that excludes a structure body that moves together with the cylinder block when the compression ratio is changed is below a straight line that connects the first position and the second position.

12. The drive device according to claim 2, wherein the portion of the support member that is supported on the vehicle body is supported on the vehicle body at a first position that is above an upper end of the crankcase, and the transmission device is supported on the vehicle body at a second position, and the first position is set at such a position that a center of gravity of a structure body of the drive device that excludes a structure body that moves together with the cylinder block when the compression ratio is changed is below a straight line that connects the first position and the second position.

13. The drive device according to claim 3, wherein the portion of the support member that is supported on the vehicle body is supported on the vehicle body at a first position that is above an upper end of the crankcase, and the transmission device is supported on the vehicle body at a second position, and the first position is set at such a position that a center of gravity of a structure body of the drive device that excludes a structure body that moves together with the cylinder block when the compression ratio is changed is below a straight line that connects the first position and the second position.

14. The drive device according to claim 11, wherein the straight line that connects the first position and the second position is set so as to form a principal axis of inertia of the drive device.
